(19) United States
(12) Patent Application Publication
(10) Pub. No.: US 2015/0339010 A1
(43) Pub. Date: Nov. 26, 2015

(54) SYSTEM AND METHOD FOR PRODUCING VIDEOS WITH OVERLAYS

(71) Applicant: Sudheer Kumar Pamuru, West Des Moines, IA (US)

(72) Inventor: Sudheer Kumar Pamuru, West Des Moines, IA (US)

(21) Appl. No.: 14/813,276

(22) Filed: Jul. 30, 2015

Related U.S. Application Data
(63) Continuation-in-part of application No. 13/555,586, filed on Jul. 23, 2012.

(51) Int. Cl. G06F 3/0482; G06F 3/0484; G06Q 30/02

(52) U.S. Cl. CPC G06F 3/0482; G06Q 30/0276; G06F 3/04847; G06F 3/04842

(57) ABSTRACT

A computer implemented method of producing videos with overlays. A user creates a video and various overlays to be applied to the video. The user selects predetermined time frames for the overlays to be provided. The system automatically generates the resulting video with the selected overlays at the predetermined time frames.

### TECHNICAL FIELD

The following disclosure relates generally to inventory video production and, more particularly, to the production of videos with overlays.

### BACKGROUND

Video advertising is known in the art. For retailers with large numbers of unique items for sale, such as used automobiles or real estate, it is desirable to produce videos of each product to allow potential buyers to view the inventory without traveling to the locations of the products, and to rapidly search and compare the products with other products. While such videos may increase the likelihood of the product being sold, and match a potential customer more quickly with a desired product, such videos often lack information desired by potential customers. It is possible to manually edit the videos to add video effects, which include additional information, and audio tracks to increase the appeal of the videos to potential customers. Manually searching and retrieving product information from a database and adding the information to the video, in the form of a video or audio effect, however, can consume an undesirable amount of time and resources that could otherwise be used to produce additional videos. Providing videos with a consistent naming convention and syndicating the videos on various platforms for access by potential customers can also be costly and time consuming. Thus, there is a need for a product video production system that reduces the amount of time and costs associated with adding video effects, audio effects, product specific information, and consistent file names to videos, and syndicating the videos on the appropriate platforms for review by potential customers.

### SUMMARY OF THE DISCLOSED SUBJECT MATTER

### Overview

A system for generating a video includes a database of information relating to a retailer's inventory of products. A video of a product in the inventory is created and matched with a record of information selected from the database that relates to the product. The video is transmitted across a network. Video effects, including the record of information, are added to the video, along with audio effects. The video is named according to a predetermined naming convention and the video is syndicated across a network for viewing by potential customers.

### BRIEF DESCRIPTION OF THE DRAWINGS

The present invention will now be described, by way of example, with reference to the accompanying drawings in which:

FIG. 1 is a component diagram of components included in a typical implementation of the system in the contest of a typical operating environment;

FIG. 2 is a flow diagram showing steps typically performed by the system to produce and syndicate a video of a product;

FIG. 3 is a display diagram showing a display of a product category menu;

FIG. 4 is a display diagram showing a display of a product menu;

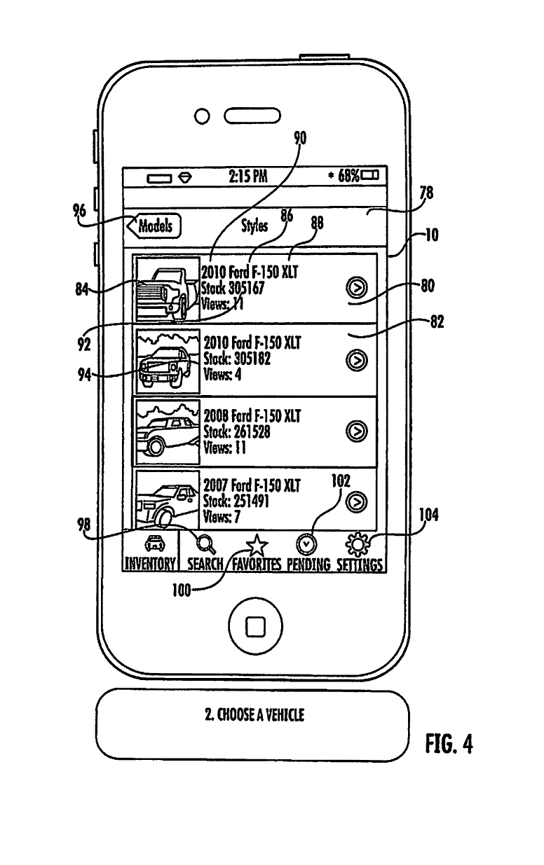

FIG. 5 is a display diagram showing a display of a record menu;

FIG. 6 is a display diagram showing a display of a digital file naming screen;

FIG. 7 is a display diagram showing a display of a recording interface;

FIG. 8 is a display diagram showing a display of a recording screen;

FIG. 9 is a display diagram showing a display of a video upload screen;

FIG. 10 is a display diagram showing a display of a video detail screen;

FIG. 11 is a display diagram showing a display of a video screen;

FIG. 12 is a flow diagram showing steps typically performed by the system to add audio and video overlays to a video; and

FIG. 13 is a display diagram showing the audio effects added to the timeline of a video.

### DETAILED DESCRIPTION OF THE DRAWINGS

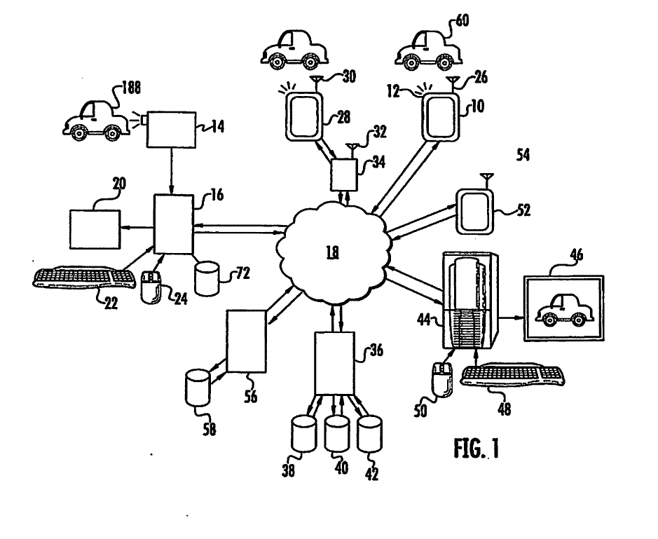

FIG. 1 is a component diagram of components included in a typical implementation of the system in the context of a typical operating environment. As illustrated, the operating environment includes one or more mobile devices (10) provided with a video capture system (12) such as a video camera. The mobile device (10) may be a computer having a memory containing computer executed instructions for processing information. The video capture system (12) may be of any type known in the art, but is preferably combined with the mobile device (10) in a mobile computing platform provided with an integrated video camera, such as an iPhone® manufactured by Apple, Inc. Preferably, the mobile device (10) is integrated with the video capture system (12).

Alternatively, a stand-alone video camera (14) may be coupled to a computer (16) having a memory containing computer executable instructions for processing information and coupled to a network (18), such as a global computing network. The computer (16) is preferably provided with a display (20) and input devices, such as a keyboard (22) and a mouse (24). The video camera (14) may be coupled to the computer (16) either using a direct wire or wireless connection.

When using the mobile device (10), the mobile device is provided with an antenna (26) to wirelessly connect to the network (18). Alternatively, a mobile device (28) may be provided with an antenna (30) to wirelessly connect to an antenna (32) provided on a base station (34) which, in turn, is coupled to the network (18). Also connected to the network (18) is a server (36) which, in turn, is coupled to one or more databases (38), (40) and (42).

Coupled to the network (18) is a user computer (44) having a memory containing computer executable instructions for processing information. The user computer (44) is coupled to a display (46) and input devices, such as a keyboard (48) and mouse (50). Other devices, such as a tablet computer (52) having an antenna (54), and a search engine server (56) coupled to a database (58), may also be coupled to the network (18). The foregoing devices may be coupled to the network (18) and to one another by any means known in the art, and may be operable in accordance with many commercial transaction communication protocols.

A retailer, such as a vehicle dealer, is provided with an inventory of items, such as vehicles. Preferably, the retailer, or some other entity, inputs into the database (38) associated with the server (36) a record of information about each item. The record of information may include a characteristic of the vehicle, such as cost, mileage, color, make, model, vehicle identification number, vehicle location, gas mileage, or any other desired information. Alternatively, the item information may be input into a database (72) associated with the retailer's computer (16). Preferably, for each item, many records of information, comprising a set of information, including primary characteristic associated with the item and one or more supplemental characteristics associated with the item, chosen from the same list, is stored on the database (38). The set of information for each item may be manually entered into the server (36) by the retailer, or the database (38) associated with the server (36) may be populated with the set of information for each item via a feed, in a manner such as that known in the art. If the retailer has other items in inventory, such as real estate, artwork, or the like, the retailer may input the set of information relating to those items into the database (38) in addition to, or in lieu of, information relating to the inventory of vehicles.

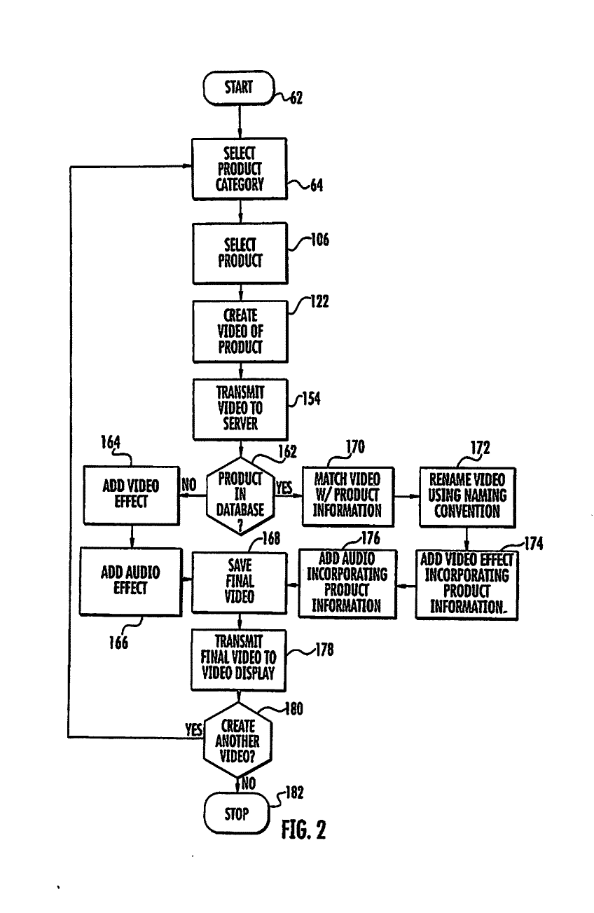

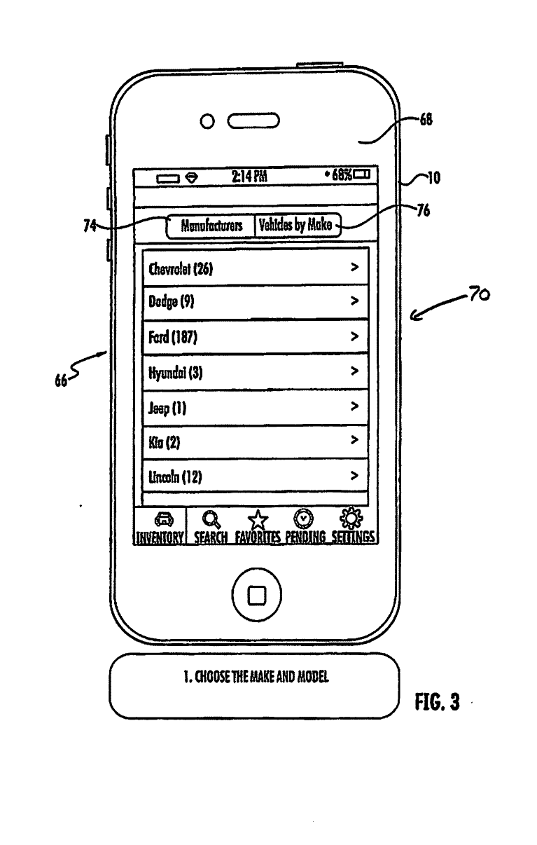

FIG. 2 is a flow diagram showing the steps typically performed by the system for generating a video of an item (60) from the inventory, such as a vehicle. The first step is for a user to use the mobile device (10) to select (64) an item category. As shown in FIG. 3, the mobile device (10) executes computer readable instructions to display an item category menu (66) on the screen (68) of the mobile device (10). The item category menu (66) displays a plurality of item characteristics (70) associated with various items stored in the database (38).

As shown in the item category menu (66), the item category menu (66) may be sorted by various criteria by selecting buttons (74) and (76) above the item category (70). Once the user selects (64) the desired item category (70) of an item desired to be the subject of the video, the mobile device (10) executes computer readable instructions to display the item menu (78) comprising details (80) and (82) relating to various vehicles having information stored in the database (38). The details (80) and (82) may include a photograph (84), the make (86), model (88) and year (90) of the vehicle. The details (80) and (82) may contain additional information such as a vehicle ID number (92) the number of views (94) associated with the vehicle. The product menu (78) also includes additional buttons, such as a “back” button (96), a “search” button (98) or “favorites” button (100) to identify entries previously tagged as “favorites” by a user. The item menu (78) may also include a “pending” button (102) to display items for which a sale is currently pending and a “settings” button (104) to adjust various user-defined settings in a manner such as that known in the art.

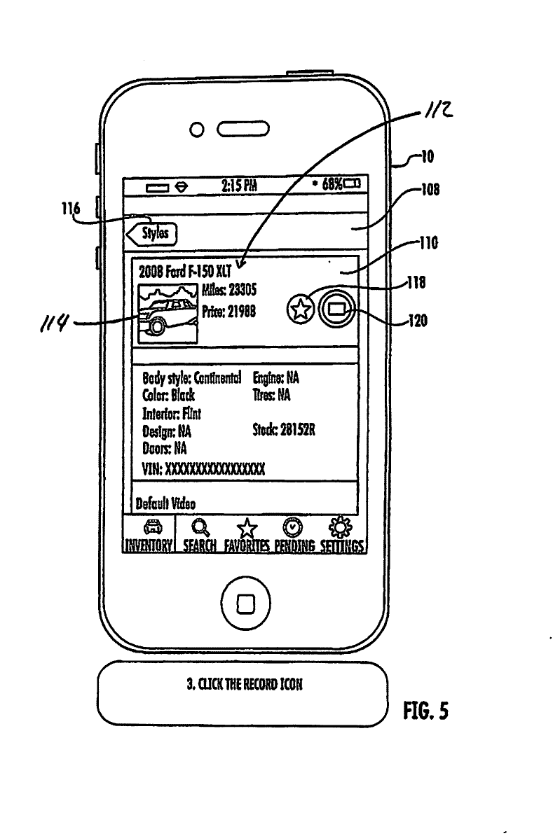

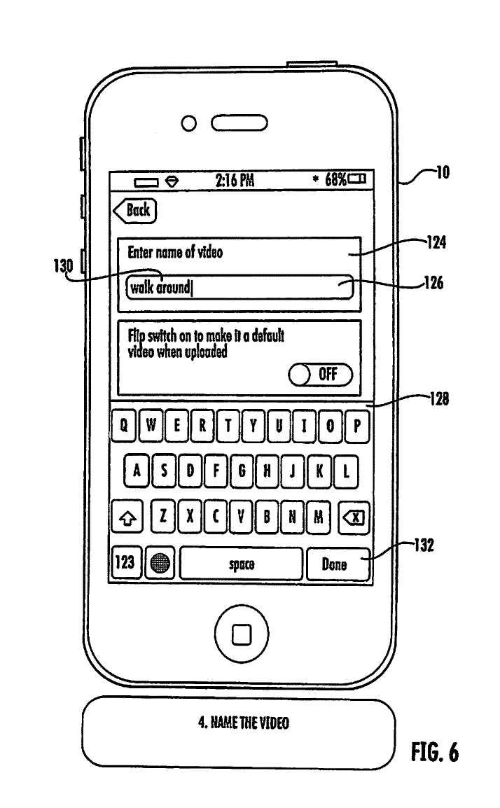

From the item menu (78), a user selects (106) the desired item for which the user wishes to create a video. Selecting (106) an item from the item menu (78) causes the mobile device (10) to execute computer-readable instructions to display the record menu (108), shown in FIG. 5. (FIGS. 2 and 5). The record menu (108) comprises a detail field (110) that includes information (112) relating to the item, along with a photograph (114) of the item (60). The record menu (108) also includes a back button (116), a favorite button (118) to tag the item as a “favorite,” and a record button (120). When it is desired to create (122) a video of the item (60), the user selects the record button (120) that causes the mobile device (10) to execute computer-readable instructions to display the video file naming screen (124). (FIGS. 2, 5 and 6).

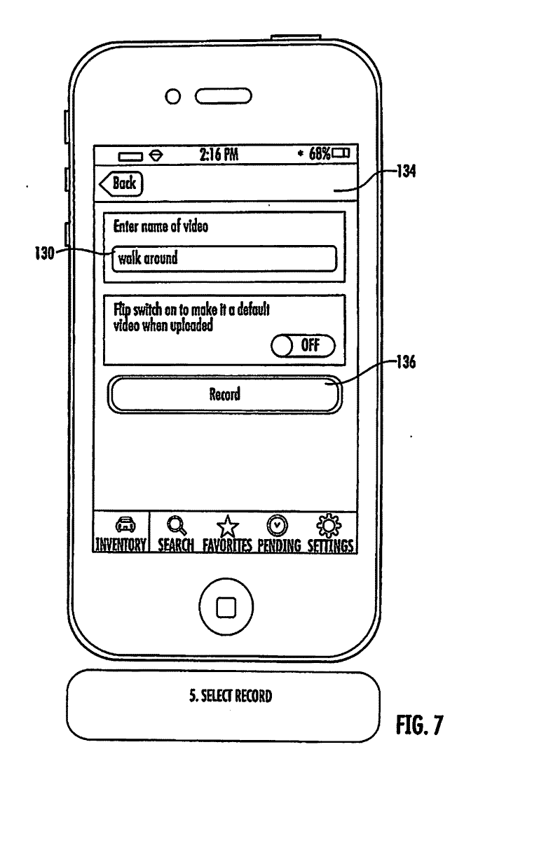

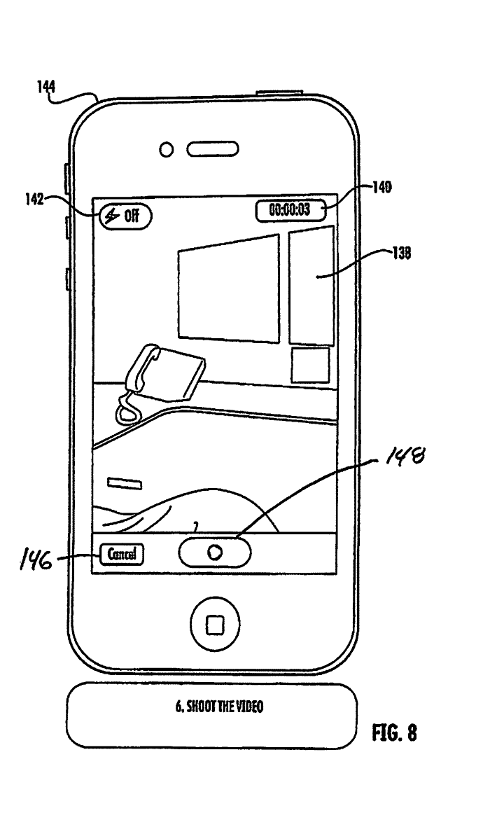

The video file naming screen (124) includes an input field (126) and a keyboard (128) to allow a user to input a file name (130) to be associated with the video. Once the user has entered the name of the video and selected the done button (132), the mobile device (10) executes computer-readable instructions to display the recording interface (134) shown in FIG. 7. The recording interface (134) includes the file name (130) and a start record button (136). Selecting the start record button (136) causes the mobile device (10) to execute computer-readable instructions to cause the video capture system (12) associated with the mobile device (10) to display the recording screen (138) and begin recording a video of the item (60). (FIGS. 2, 7 and 8). The recording screen (138) includes a timer (140), a light button (142) to toggle on and off a light (144) associated with the mobile device (10), a cancel button (146) to cancel the video recording, and a stop recording button (148) to stop the recording when the video is complete.

Once the user selects the stop recording button (148), the mobile device (10) executes computer-readable instructions to associate the video with the record of information selected from the database (38), to create an associated video. The mobile device (10) may use a program, such as a software application resident on the mobile device (10), to make the association, or may use an application stored on the server (36) or elsewhere, to associate the video with the record of information selected from the database (38). The associated video may be the recorded video associated with at least some aspect of the record of information selected from the database (38). The association may be naming the video using a naming convention associating the video with the record of information. The association may be a piece of code provided in the video file code that is associated with the record of information. The association is preferably anything that allows a server to associate the video with the set of information, including a primary characteristic associated with the item and one or more supplemental characteristics associated with the item selected from the database (38).

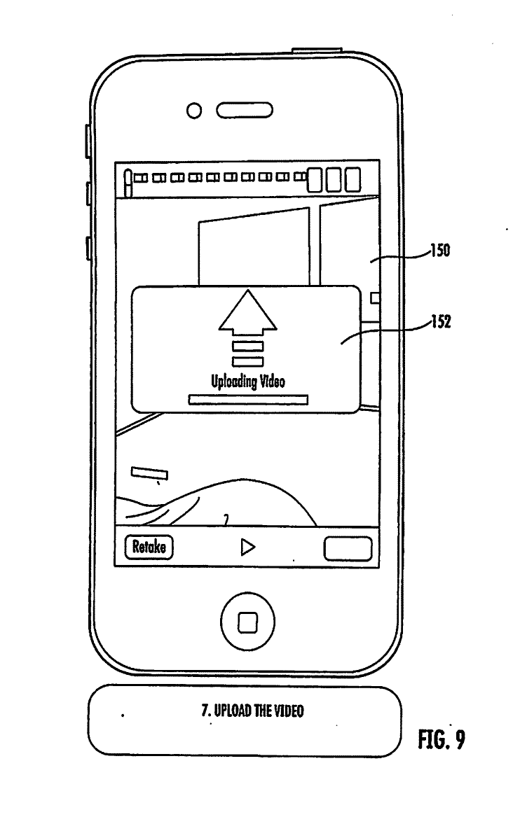

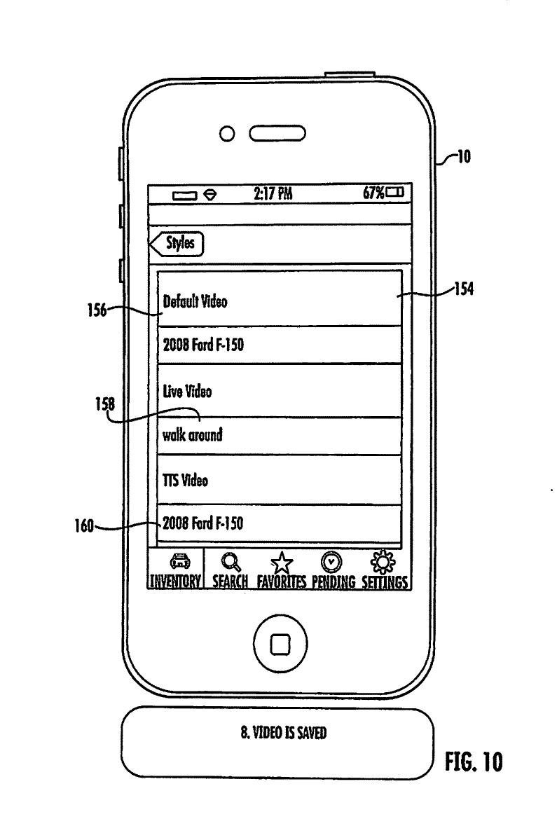

The mobile device (10) displays the associated video uploading screen (150) including a status bar (152) indicating automatic transmission (154) of the associated video from the mobile device (10) across the network (18) to the server (36). (FIGS. 1, 2, 8, and 9). Once the transmission (154) of the associated video to the server (36) is complete, the mobile device (10) executes computer-readable instructions to display the video detail screen (156) that lists the various categories of videos, such as a designated default video (158), the most recent video (160), as well as additional categories. (FIGS. 1, 2, 9, and 10). Once the server (36) has received the associated video, the server (36) checks (162) the database (38) to see if the product exists in the database (38) and, if the product exists, accesses the record of information associated with the associated video.

As shown in FIG. 2, if the item is located in the database (38), the server (36) processes the associated video to create a modified video. The processing may include adding (164) predetermined video effects to the associated video, such as swipes and dissolves. The server (36) may add (164) a video overlay that includes a primary characteristic associated with the vehicle, such as the price of the vehicle. The server (36) may also add (164) a supplemental video overlay that includes a supplemental characteristic associated with the vehicle, such as the location of the vehicle.

If desired, the video may be associated with a record of information at the server (36). In this embodiment, the server checks (162) and finds information related to the item in the database (38), the server (36) matches (170) the video with the item information stored in the database (38). The server (36) then renames (172) the video, or otherwise annotates the video to create the associated video and indicate that the associated video is associated with the record of information stored in the database (38). After renaming (172) the associated video, the server (36) adds (174) video effects to the associated video. Preferably, the server (36) adds (174) video effects to the associated video that incorporates at least a portion of the record of information stored in the server (38). Such video effects may include video overlays of information related to the price, mileage, condition, color, make, model or other stored characteristic of the item (60).

The server (36) may also add (176) audio effects to the associated video that incorporate at least a portion of the record of information. Such audio effects may include automated voiceovers relating to price, condition, color, mileage, or other characteristic of the item (60). Once the server (36) has completed the addition of video and audio effects to the associated video, the server (36) saves (168) the modified video on the server (36). While the associated video may be edited manually, in the preferred embodiment, the server (36) automatically adds (174) and (176) video and audio effects in automatic response to transmission (154) of the associated video to the server. Once the server (36) has saved (168) the modified video, the server (36) may upload the modified video to the retailer's computer (16), which the retailer may store in the database (72) coupled to the computer (16). The server (36) may also transmit (178) the modified video to a user's computer (44) associated with a prospective customer for viewing on the display (46). Alternatively, the server (36) may upload the modified video to a subscription website, such as youtube.com, syndicate the modified video, or upload the modified video to a third party server for access therefrom by potential customers. Thereafter, a user may decide (180) whether to create another video. If the user wishes to create another video, the process returns to (64) and repeats. If the user does not wish to create another video, this routine finishes (182).

As shown in FIG. 1, any desired device, such as a tablet (52) may be used to create and send the associated video to the server (36) across the network (18), or to display modified videos received from the server (36). Additionally, a search engine (56) may be used to search and access modified videos stored on the server (36) or elsewhere.

As shown in FIG. 1, a supplemental retailer, having a second inventory comprising a supplemental item (184) may enter into the database (38) associated with the server (36), a supplemental set of information, including a primary characteristic and supplemental characteristic associated with the supplemental item (184). The supplemental retailer may use the stand-alone video camera (14) to create a supplemental video of the supplemental item (184). The supplemental retailer may then transfer the supplemental video, either directly, or via the computer (16), across the network (18), to the server (36). The server (36) associates the supplemental video with the supplemental set of information in the database (38) associated with the supplemental item (184), in a manner such as that described above, to create a supplemental associated video. The server (36) then processes the supplemental associated video, in a manner described above, to create a supplemental modified video. The server (36) saves the supplemental modified video, and may upload the supplemental modified video to the supplemental retailer's computer (16). The supplemental retailer may store the supplemental modified video in a supplemental database coupled to the supplemental retailer's computer (16). The server (36) may also transmit the supplemental modified video to a supplemental user's computer for viewing on a supplemental display.

As shown in FIGS. 1, 11 and 12, if it is desired to add (166) video overlays (186), the server (36) is provided with a program, that may include software that accesses a plurality of videos (188) stored on the database (38). The server (36) is designed to collect (190) data regarding the video viewing habits of a plurality of users. The server (36) is provided with access to a plurality of filters stored on the database (38). The filters define subsets of information relating to the videos (188) and/or users. The filters may include, but are not limited to: products in the videos; information provided by retailers or third-parties; user locations; the number of videos watched; dates and times of video viewing; previous videos watched; subsequent videos watched; length of videos watched; early termination of video viewing; number of viewings of a video; video effects in videos watched; audio effects in videos watched; the time of year, the time of day, the day of the month; the local weather; as well as any similar characteristics known in the art. A filter may relate to one criterion, multiple criteria, or a more complex algorithm incorporating multiple criteria. Multiple filters may also be used in combination to obtain the desired result. Preferably, filters are rule-based actions based upon aggregate information across multiple users, but filters may be behavior-based actions, based upon a single user.

The server (36) selects one or more filters, based upon predetermined criteria, and selects audio and/or video effects, such as banners or music to add to the video. The server (36) also selects a predetermined time in the video, and predetermined duration, to overlay the audio and/or video effects, and automatically adds the selected effects to a video at the predetermined times, for the predetermined durations. For example, the server may receive a request from a user, from the mobile device (10) for a video advertising a certain automobile.

Based upon the request, the server (36) may be configured to select filters based upon the viewing habits of users located near the requesting user and users viewing a similar number of videos as the requesting user has viewed within a predetermined timeframe. Based upon these filters, the server (36) may be configured to insert a “4×4 for winter” banner between ten and twenty seconds into the video, a “$100 test drive incentive” banner during the last ten seconds of the video, and an audio clip detailing the winter driving capabilities of the vehicle during the first twenty seconds of the video. The “4×4 for winter” banner may be selected based upon the time of the year or the viewing habits of other users located near the user. The “$100 test drive incentive” banner may be selected based upon the number of times the user has watched the video compared to the number of times other users have watched the video. Banners may be static, or interactive. If the “$100 test drive incentive” is interactive, when the user selects the banner, the server (36) stops the video and displays information relating to the incentive. The audio clip detailing the winter driving capabilities of the vehicle may be selected based upon the number of other users viewing similarly equipped vehicles near the user's location. The insertion times and duration of the effects may be based upon similar or different criteria. Once the server (36) has added the desired effects, the user watches the video with the desired effects at the desired times and for the desired durations.

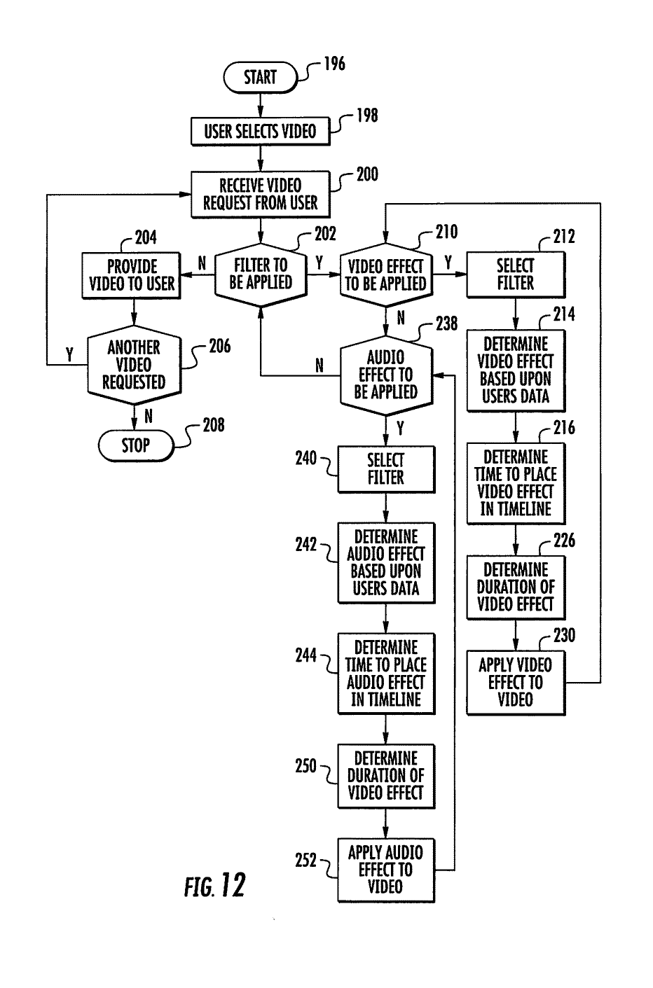

FIG. 12 is a flow diagram showing the steps typically performed by the system for using filters to add video overlays (184) and audio overlays (192) to a video (194). The process starts (196) with the user selecting (198) a video using a device such as the mobile device (10). (FIGS. 1, 11, and 12). The request is received (200) by the server (36), and the server (36) determines (202) whether a filter is to be applied to the video, before returning the video (194) to the user. If the server (36) determines (202) that no filter is to be applied to the video (194), the server (36) instructs the server (36) to provide (204) the video (194) to the user. If the server (36) determines (206) that additional videos have been requested, the process returns to step (200) and repeats. If the server (36) determines (206) that no additional videos have been requested, the process stops (208).

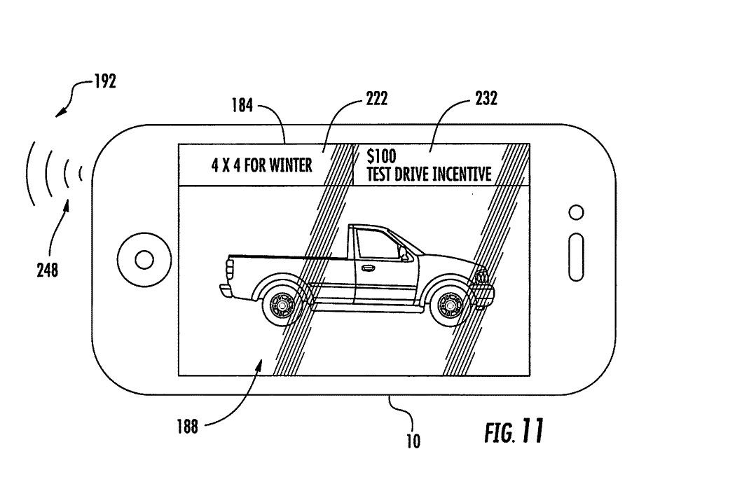

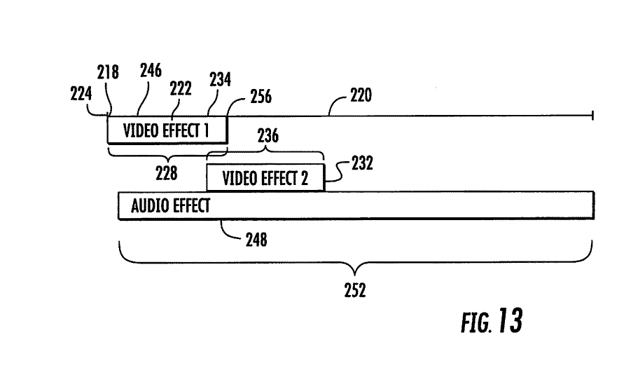

If the server (36) determines (202) that a filter is to be applied to the video (194), the server (36) determines (210) if a video effect, such as and intro or outro video, or a banner advertisement, is to be applied. If a video effect is to be applied, the server (36) selects (212) the appropriate filter from the database (38), based upon the identity of the user, the location of the user, or any other predetermined criteria. The server (36) uses the filter to determine (214) the appropriate video effect from the database (38). The server (36) also uses the filter to determine (216) the time (218) along the timeline (220) of the video to insert the video effect (222). As shown in FIG. 13, this time (218) is at the start (224) of the timeline (220). The server (36) uses the filter to determine (226) the duration (228) of the video effect (222). The server (36) then applies (230) the video effect (222) to the video. (FIGS. 11-13). Once the video effect (222) has been applied, the process returns to step (210) to determine if another video effect is to be applied. If another video effect is to be applied, the process repeats and another video effect (232) is applied to the video at a time (234) along the timeline (220), for a duration (236) determined by the appropriate filter from the database (38).

If the server (36) determines (210) that there are no more video effects to be applied to the video, the server (36) determines (238) if an audio effect is to be applied. If an audio effect is to be applied, the server (36) selects (240) the appropriate filter from the database (38), based upon the identity of the user, the location of the user, or any other predetermined criteria. The server (36) uses the filter to determine (242) the appropriate audio effect from the database (38). The server (36) also uses the filter to determine (244) the time (246) along the timeline (220) of the video to insert the audio effect (248). The server (36) uses the filter to determine (250) the duration (252) of the audio effect (248). The server (36) then applies (252) the audio effect (248) to the video. (FIGS. 11-13). Once the audio effect (248) has been applied, the process returns to step (238) to determine if another audio effect is to be applied. If another audio effect is to be applied, the process repeats and another audio effect is applied to the video in a manner similar to that described above. As shown in FIG. 13, the first video effect (222) takes priority over the second video effect (232) if both effects cannot be displayed simultaneously, and the audio effect (248) takes priority over any subsequent audio effects if the audio effects cannot be presented simultaneously.

If no more audio effects are to be applied to the video, the process returns to step (202). If there are no more filters to be applied, the process moves to step (204), where the server (36) instructs the server (36) to provide (204) the completed video (254) to the user, which is displayed on the mobile device (10) for the user to view. If desired, the program may be configured to allow modification of the timeline (220). For example, the mobile device (10) may display the timeline (220) with a drag-and-drop feature, such as those known in the art, to allow the first video effect (222), second video effect (232), and audio effect (248) to be moved to different places along the timeline (220), to be manipulated in terms of duration, or to allow one effect to take precedence over another effect if the effects overlap on the timeline (222) and cannot be presented at the same time. Similarly, the server (36) may allow the option of previewing the completed video (254) before the completed video (245) is provided to the user. If the program determines (206) that additional videos have been requested, the process returns to step (200) and repeats. If the program determines (206) that no additional videos have been requested, the process stops (208).

As shown in FIG. 13, at a certain time (256) on the timeline (220) the first video effect (222), second video effect (232), and audio effect (248) overlap. Accordingly, as shown in FIG. 11, at this time (256), the completed video (254) displayed to the user shows both the first video effect (222) and the second video effect (232) while the audio effect (248) plays through the mobile device (10).

Audio and video effects may be applied to the completed video (254) in a non-interactive manner, where the effects are part of the completed video (254) itself, or in an interactive manner, where the effects are part of the media player playing the completed video (254). While the server (36) preferably selects the desired filters, in an alternative embodiment, the server (36) may present the user with the opportunity to select desired filters, so that the user may be presented with incentive effects, specification effects, option effects, or any other desired effects. If desired, the program may use a “push” service to asynchronously provide videos to a user. In this embodiment, a user subscribes to the service, indicating video preferences in advance. When content meeting the indicated preferences becomes available, the server (36) asynchronously pushes the content to the user's mobile device (10), without the need for a separate request from the user.

Although a few implementations have been described in detail above, other modifications are possible. Moreover, other mechanisms for generating video, matching the video with product information, and incorporating the product information into the video in the form of video effects may be used. In addition, the logic flow depicted in FIG. 2 does not require the particulars order shown or sequential order to achieve the desirable result. Other steps may be provided, or steps may be eliminated from the described flow, and other components may be added to, or removed from, the described systems. Accordingly, other implementations are within the scope of the following claims.

What is claimed is:

1. A computer-implemented method for generating a modified video, performed on one or more computing devices, the method comprising:
(a) creating a video;
(b) providing a database comprising a plurality of video overlays;
(c) selecting, using the one or more computing devices, a first video overlay from the database;
(d) selecting, using the one or more computing devices, a first predetermined time of the video in which to overlay the first video overlay;
(e) overlaying the first video overlay onto the video at the first predetermined time;
(f) selecting, using the one or more computing devices, a second video overlay from the database;
(g) selecting, using the one or more computing devices, a second predetermined time of the video in which to overlay the second video overlay;
(h) overlaying the second video overlay onto the video onto which the first video overlay is overlaid, at the second predetermined time to create a second modified video; and
(i) viewing the video onto which the first video overlay is overlaid at the first predetermined time and onto which the second video overlay is overlaid at the second predetermined time.

2. The computer-implemented method for generating a modified video of claim 1, wherein the first video overlay is selected based upon using the one or more computing devices to make an association between the video and the first video overlay.

3. The computer-implemented method for generating a modified video of claim 2, wherein the association is based upon the actions of a plurality of users who have watched videos with predetermined similarities with the video.

4. The computer-implemented method for generating a modified video of claim 3, wherein the predetermined similarities comprise the type of content displayed in the video.

5. The computer-implemented method for generating a modified video of claim 2, wherein the association is based upon the location of a plurality of users who have watched the video.

6. The computer-implemented method for generating a modified video of claim 2, wherein the second video overlay is selected based upon using the one or more computing devices to make a supplemental association between the video and the second video overlay.

7. The computer-implemented method for generating a modified video of claim 6, wherein the supplemental association is based upon the actions of a supplemental plurality of users who have watched videos with predetermined similarities with the video.

8. The computer-implemented method for generating a modified video of claim 6, wherein at least some of the users in the plurality of users are different than at least some of the users in the supplemental plurality of users.

9. The computer-implemented method for generating a modified video of claim 2, wherein the association is based upon information associated with a user watching the video.

10. A computer-implemented method for generating a modified video, performed on one or more computing devices, the method comprising:
(a) providing a plurality of videos;
(b) collecting data regarding videos viewed by a plurality of users;
(c) making a first association, using the one or more computing devices, between videos viewed by a first plurality of users;
(d) providing a database comprising a plurality of video overlays;
(e) selecting a video from a plurality of videos;
(f) using the first association and the one or more computing devices, to select a first video overlay from the database;
(g) selecting, using the one or more computing devices, a first predetermined time of the video in which to overlay the first video overlay;
(h) overlaying the first video overlay onto the video at the first predetermined time;
(i) making a second association, using the one or more computing devices, between videos viewed by a second plurality of users;
(j) using the second association and the one or more computing devices, to select a second video overlay from the database;
(k) selecting, using the one or more computing devices, a second predetermined time of the video in which to overlay the second video overlay;
(l) overlaying the second video overlay onto the video at the second predetermined time; and
(m) viewing the video with the first video overlay and the second video overlay.

11. The computer-implemented method for generating a modified video of claim 10, wherein the first association is based upon the actions of the first plurality of users.

12. The computer-implemented method for generating a modified video of claim 10, wherein the first association is based upon the locations of the first plurality of users.

13. The computer-implemented method for generating a modified video of claim 10, wherein the first plurality of users is the same as the second plurality of users.

14. The computer-implemented method for generating a modified video of claim 10, wherein the first plurality of users is different than the second plurality of users.

15. The computer-implemented method for generating a modified video of claim 14, wherein the first association is based upon the actions of the first plurality of users.

16. The computer-implemented method for generating a modified video of claim 15, wherein the second association is based upon the locations of the second plurality of users.

17. A computer-implemented method for generating a modified video, performed on one or more computing devices, the method comprising:
(a) providing a plurality of videos;
(b) collecting data regarding videos viewed by a plurality of users;
(c) providing a database comprising a plurality of video overlays;
(d) providing a plurality of filters associated with the plurality of users;
(e) selecting a video from the plurality of videos;
(f) using the one or more computing devices to use a first filter selected from the plurality of filters to select a first video overlay from the database;
(g) selecting, using the one or more computing devices, a first predetermined time of the video at which to overlay the first video overlay;
(h) overlaying, using the one or more computing devices, the first video overlay onto the video at the first predetermined time;
(i) using the one or more computing devices to use a second filter selected from the plurality of filters to select a second video overlay from the database;
(j) selecting, using the one or more computing devices, a second predetermined time of the video at which to overlay the second video overlay;
(k) overlaying, using the one or more computing devices, the second video overlay onto the video at the second predetermined time; and
(l) viewing the video with the first video overlay at the first predetermined time and the second video overlay at the second predetermined time.

18. The computer-implemented method for generating a modified video of claim 17, wherein the first filter is associated with the actions of a first subset of the plurality of users.

19. The computer-implemented method for generating a modified video of claim 18, wherein the second filter is associated with the locations of a second subset of the plurality of users.

20. The computer-implemented method for generating a modified video of claim 18, wherein the predetermined time is selected based upon an association with the plurality of users.
